(19) United States
(12) Patent Application Publication
(10) Pub. No.: US 2026/0365542 A1
(43) Pub. Date: Nov. 19, 2026

(54) RECYCLING COMPONENTS OF SUPPORTED PALLADIUM AND PLATINUM CATALYSTS

(71) Applicant: JOHNSON MATTHEY PUBLIC LIMITED COMPANY, London (GB)

(72) Inventors: Michael TURNER JONES, Royston (GB); Hazel Mary REID, Royston (GB); Stephen SPELLER, Royston (GB); Mark David TURTON, Royston (GB); Rebecca Louise WITTON, Royston (GB)

(21) Appl. No.: 19/132,241

(22) PCT Filed: Nov. 8, 2023
(86) PCT No.: PCT/GB2023/052917

§ 371 Date: May 22, 2025

(30) Foreign Application Priority Data
Jan. 16, 2023 (GB) 2300598.6

(51) Int. Cl. C01G 55/00; B01D 15/36; B01D 15/42; C22B 3/00; C22B 3/24; C22B 7/00; C22B 11/00; C22B 25/06; C22B 34/34

(52) U.S. Cl. CPC C01G 55/002; B01D 15/361; B01D 15/426; C01G 55/001; C22B 3/24; C22B 7/007; C22B 11/048; C22B 25/04; C22B 25/06; C22B 34/345

(57) ABSTRACT

A method of recycling a supported palladium or platinum catalyst comprising palladium or platinum and base metal disposed on a ceramic support, the method comprising: leaching the palladium or platinum and the base metal from the ceramic support using a hydrochloric acid leachate to produce a hydrochloric acid leach liquor comprising the palladium or platinum and the base metal; passing the leach liquor through a column comprising material which selectively adsorbs the palladium or platinum; eluting the palladium or platinum from the column using an eluent to produce a solution comprising the palladium or platinum; and treating the solution comprising the palladium or platinum to recover the palladium or platinum.

### FIELD

The present specification relates to a method of recycling components of supported palladium and platinum catalysts.

### BACKGROUND

Catalysts comprising one or more platinum group metals (PGMs) are well known to be useful in a wide range of applications. One or more PGMs can also be combined with one or more base metals to provide mixed metal catalysts. Furthermore, PGM catalysts can be provided on a support material, such as ceramic support materials, to provide supported catalyst materials.

Palladium and platinum catalysts are particularly useful for certain applications. As discussed generally above for PGM catalysts, such catalysts can comprise palladium or platinum combined with one or more base metals (or non-PGMs) and such catalysts can be provided on a support material such as a ceramic support.

With increasing demands for PGMs, there is an increasing demand to recycle and re-use these materials. Furthermore, there is an increasing need to achieve recycling of PGMs in a more energy efficient, economical, sustainable, and environmentally friendly manner. Further still, there is also a need to recycle PGMs from multi-component materials in a manner which enables the recycling of one or more of the other components, e.g., the support material of a supported PGM catalyst.

In relation to the above, recovery of platinum group metals (PGMs) from supported catalyst materials is typically achieved by smelting. This involves thermally processing the supported PGM material, which can be energy intensive, costly, and can cause environmental damage and pollution. For mixed metal catalysts, such smelting processes can result in a mixed metal alloy which requires significant further processing to extract and purify the PGM component(s). Further still, such smelting processes can also damage the support material rendering it unsuitable for re-use.

It is an aim of the present specification to address these problems.

### SUMMARY OF INVENTION

The present specification provides a method of recycling a supported palladium or platinum catalyst comprising palladium or platinum and base metal disposed on a ceramic support, the method comprising:
leaching the palladium or platinum and the base metal from the ceramic support using a hydrochloric acid leachate to produce a hydrochloric acid leach liquor comprising the palladium or platinum and the base metal;
passing the leach liquor through a column comprising material which selectively adsorbs the palladium or platinum;
eluting the palladium or platinum from the column using an eluent to produce a solution comprising the palladium or platinum; and
treating the solution comprising the palladium or platinum to recover the palladium or platinum.

This process recovers palladium or platinum by a hydrometallurgy route with the potential for the ceramic support to be reused. It provides a more sustainable recycling route compared to smelting, as the supported palladium/platinum catalyst doesn't need to be thermally treated. The ceramic support can be a metal oxide, a metal nitride, or a metal carbide material. An advantage of examples of the present methodology is that the ceramic support is not subjected to a thermal or chemical decomposition treatment. Accordingly, after leaching the palladium or platinum and the base metal from the ceramic support, the ceramic support can be recovered and re-used.

The base metal may comprise more than one type of base metal. For example, the base metal may comprise or consist of one or more transition metals and/or one or more post-transition metals. Examples include one or both of tin and molybdenum. The ceramic support may comprise or consist of zirconia. It has been found that palladium/platinum and base metals such as tin and molybdenum can be leached from a ceramic support such as zirconia using a hydrochloric acid leachate to produce a hydrochloric acid leach liquor comprising the palladium/platinum and the base metal(s). Furthermore, the ceramic support can be recovered and re-used.

It has further been found that commercially available ion exchange/molecular recognition materials in a column can be used to selectively adsorb palladium/platinum from the leach liquor with the base metal passing through the column. The palladium/platinum can then be eluted from the column and recovered, e.g., via precipitation as a palladium/platinum salt. As such, the methodology enables the recovery of both the palladium/platinum and the ceramic support (and optionally the base metal(s)) using a hydrometallurgical route which avoids smelting and treatments which would damage the support material.

The hydrochloric acid leachate may have a hydrochloric acid concentration of: at least 1 M, 2 M, or 3 M; no more than 8 M, 7.5 M, or 7 M; or within a range defined by any combination of the aforementioned lower and upper limits. The hydrochloric acid leachate may further comprise an oxidant such as hydrogen peroxide or chlorate. The leaching step can be carried out at a temperature of: at least 20, 30, or 40 °C; no more than 95, 80, or 70 °C; or within a range defined by any combination of the aforementioned lower and upper limits. Furthermore, the supported palladium/platinum catalyst can be ground or milled prior to leaching. Grinding or milling the supported palladium/platinum catalyst can reduce the requirement to use an oxidant. It should be noted that while the grinding or milling may reduce the particle size of the ceramic support material, the material is not thermally or chemically degraded and thus can still be re-cycled.

The column used to selectively adsorb the palladium/platinum from the leach liquor can comprise a polymer ion exchange/molecular recognition resin such as the commercially available SuperLig™ resins (e.g., the SuperLig™ 2 resin for selective Pd extraction). Palladium/platinum can then be recovered from the column. For example, palladium can be recovered by elution using (NH₄)₂SO₃ or NH₄HSO₃ followed by precipitation as a Pd(NH₃)₂Cl₂ salt by, for example, treating the eluted solution with HCl and H₂O₂.

After leaching the palladium/platinum and the base metal from the ceramic support, the ceramic support can be recovered and re-used.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a graph of % metal leached vs molarity of acid for palladium, tin and molybdenum;

FIG. 2 shows a graph of metal mass leached vs volume of oxidant added for palladium, tin and molybdenum;

FIG. 3 shows a graph of % metal leached vs volume of oxidant added for palladium, tin and molybdenum;

FIG. 4 shows a supported catalyst before leaching (palladium, tin, and molybdenum on zirconia);

FIG. 5 shows the catalyst of FIG. 4 after leaching;

FIG. 6 shows a graph of leached metal concentration vs time during initial leaching using HCl only followed by leaching using HCl and sodium chlorate;

FIG. 7 shows a graph of % leached metal vs time during initial leaching using HCl only followed by leaching using HCl and sodium chlorate; and

FIG. 8 shows a graph of % leached metal vs volume of H₂O₂ added.

### DETAILED DESCRIPTION

As described in the summary section, the present specification provides a method of recycling a supported palladium or platinum catalyst comprising palladium or platinum and base metal disposed on a ceramic support, the method comprising:
leaching the palladium or platinum and the base metal from the ceramic support using a hydrochloric acid leachate to produce a hydrochloric acid leach liquor comprising the palladium or platinum and the base metal;
passing the leach liquor through a column comprising material which selectively adsorbs the palladium (e.g., an ion exchange or molecular recognition resin);
eluting the palladium or platinum from the column using an eluent to produce a solution comprising the palladium or platinum; and
treating the solution comprising the palladium or platinum to recover the palladium or platinum.

This process recovers palladium or platinum by a hydrometallurgy route with the potential for the ceramic support to be reused. It provides a more sustainable recycling route compared to smelting, as the supported palladium/platinum catalyst doesn't need to be thermally treated and ion exchange/molecular recognition columns can be reused for hundreds of cycles prior to replacement of ion exchange/molecular recognition resin.

The process has been exemplified for a catalyst comprising Pd/Sn/Mo supported on zirconia. It has been demonstrated that Pd/Sn/Mo can be leached in HCl (0-8 M) with or without addition of an oxidant such as hydrogen peroxide or chlorate. The process can be carried out at temperatures ranging from 20-95 °C and the catalyst material can be processed as received or via grinding or milling prior to leaching.

After leaching, the leach liquor can then be concentrated (e.g., by boiling down) and passed through an ion exchange/molecular recognition resin, such as SuperLig™ 2, where the Pd is retained on the resin and the Sn and Mo pass through the column. The Pd can then be removed from the column using, for example, ammonium sulphite. The Pd ammonium sulphite solution can then be treated with HCl and hydrogen peroxide and the Pd is precipitated as diammine dichloropalladium.

The process can be run as a batch process or as a continuous process. Leaching of the catalyst can be performed by packing the catalyst into a column and then circulating/recirculating the acid leachate through the column.

The process enables a Pd or Pt recovery route for supported Pd(or Pt)/base metal catalysts such as a catalyst comprising Pd/Sn/Mo supported on zirconia.

### EXAMPLES

### Example 1: Leaching of Catalyst Material (Palladium, Tin, and Molybdenum on Zirconia) at Varying HCl Molarities

40.2 g of spent catalyst (palladium, tin, and molybdenum on zirconia) was weighed directly into a 1 L flat bottomed baffled borosilicate flanged glass reactor. 400 ml demineralized water was added before inserting an overhead stirrer, and attaching a five-port borosilicate glass lid, clamped in place. The stirrer was attached to an overhead stirrer motor, and the reactor vessel was clamped in place. Three of the five ports were closed with glass stoppers. The stirrer was submerged to approximately 3 cm from the base of the reactor. The experiment was conducted at room temperature. The reaction vessel contained supported catalyst (palladium, tin, and molybdenum on zirconia) in demineralized water prior to addition of HCl.

The stirrer was set to 300 rpm. There was a slight visual change of clear to cloudy, most likely due to the presence of fines within the material, and some bubbles of gas were released. A sample was taken after 20 minutes. To take a sample, the stirrer motor was stopped, and a plastic pipette was used to measure out 5 mL into a 5 mL measuring cylinder and transferred to a sample vial.

After the initial sample was taken, a first addition of 20 mL 37% HCl was added from a measuring cylinder via one of the open ports. An immediate colour change was visible-cloudy to a pale orange colour. The reaction mixture was left for 10 minutes and then sampled.

20 mL HCl additions were repeated at 10 minutes intervals for the next 11 additions. Prior to the acid addition, a 5 ml sample was taken as described previously.

During these additions, the colour gradually darkened through stronger orange, to brown, to brown-green before becoming so dark in the reactor it was difficult to identify any colour changes.

From addition 13, the acid volume was increased to account for a larger total volume, and to increase the molarity between each addition: 13th addition=30 ml; 14th addition=35 mL; 15th addition=40 mL; 16th addition=45 mL; 17th addition=50 mL. The reaction vessel was thus subjected to stepwise additions of HCl prior to filtration. A range of samples were taken from the reaction vessel for subsequent metal content analysis during the stepwise addition of HCl.

After the final post-acid-addition sample was taken, the stirrer motor was stopped and the reaction left to sit for approximately half an hour before filtering by vacuum filtration into a 1 L Buchner flask through a 7 cm diameter GF/F (0.7 μm porosity) filter, which took around 5 minutes. The liquor was weighed, and volume measured before transferring to a 1 L bottle (net volume 711 mL, net weight 781.15 g). A sample of the final filtered liquor was taken.

The same filter and Buchner were used to wash through the remaining solid and rinse out any associated glassware of liquor. This was left to pull dry for around 5 minutes until satisfied that the sample looked clean and dry. The washings had a pale orange colour to them and were clear. These were weighed, and volume measured before transferring to a 500 ml bottle (net weight 291.63 g and net volume 290 mL).

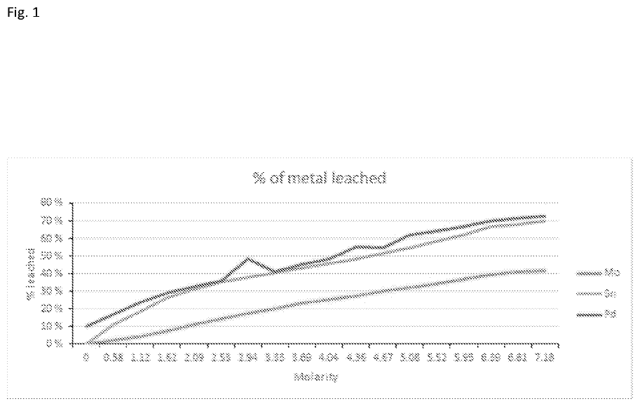

All samples were sent for metal content analysis via ICP (Inductively Coupled Plasma) spectroscopy. FIG. 1 shows a graph of % metal leached vs molarity of acid for palladium, tin and molybdenum. It is notable that the base metal (Sn and Mo) is leached with the palladium and that selective leaching of palladium is not achieved. As such, these trials indicated that the palladium and base metal should be leached together and then the palladium subsequently separated from the base metal to recover the palladium, e.g., via reduction to Pd metal or via precipitation as a Pd salt.

### Example 2: HCl Leaching of Catalyst Material Using H₂O₂ as an Oxidiser

Following the previous example, the aim is strip all, or at least substantially all, of the Pd, Mo and Sn from the zirconia base of the spent catalyst material using 7 M HCl and an oxidiser (H₂O₂) at a max flow rate of 0.17 mL/min.

35 g of catalyst material was weighed into a 500 ml flange vessel and set up on a hotplate with overhead stirrer, condenser and temperature probe. 350 mL of 7 M HCl was added using a glass funnel in one of the available ports and the temperature set to 70 °C. A Gilson pump was set up with pump rate set to 0.5 speed (0.05 mL/min). The tube was primed and inserted into an available port through a connector and sealed off with parafilm. The overhead stirrer was set to 150 rpm.

Once the 70 °C temperature was reached, addition of peroxide was started at the lowest speed and observed to ensure the reaction wasn't too effervescent. After 5 minutes the rate of peroxide addition was increased to 0.75 (0.08 mL/min). It was further increased to 1 (0.11 mL/min) after 17 minutes, and again to 1.25 (0.14 mL/min) after 15 minutes, and finally to 1.5 (0.17 mL/min) after 30 minutes.

The reaction continued at the rate of 0.17 mL/min for 3.5 hours. Samples were taken prior to H₂O₂ addition and then every hour. A further sample was taken after cooling and a final sample taken after filtration. The resultant liquor was filtered via vacuum filtration through a GF/F filter paper into a Buchner funnel. Residue was dried under vacuum for 10 minutes before being left to air dry.

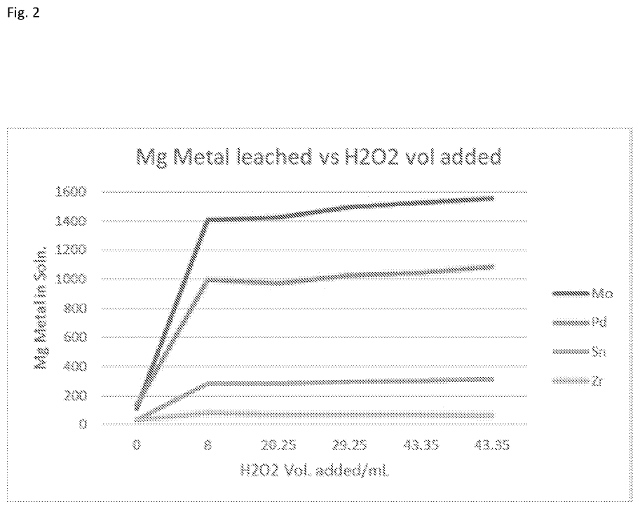

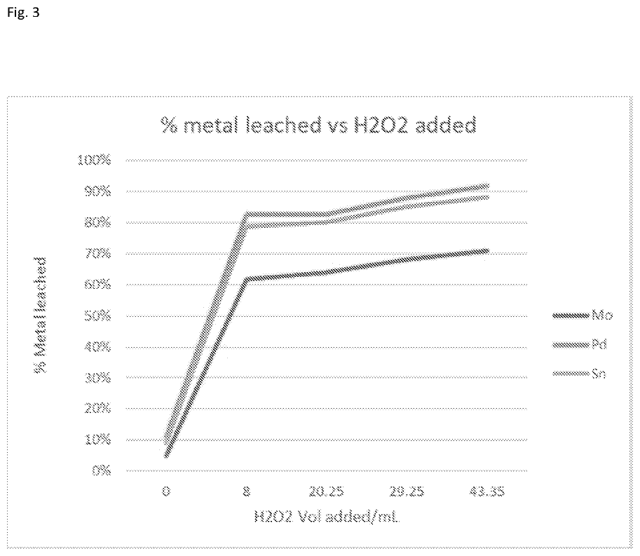

Seven samples were analysed by ICP spectroscopy. FIG. 2 shows a graph of metal mass leached vs volume of oxidant added for palladium, tin and molybdenum while FIG. 3 shows a graph of % metal leached vs volume of oxidant added for palladium, tin and molybdenum.

Results show an increase in leaching of all metals when using a combination of hydrogen peroxide and HCl when compared to the use of HCl alone. 80% of Pd and Sn were removed in the first 8 ml (~1 hour) followed by another ~10% over ~3 hours or 30 ml peroxide. The process can remove substantially all metals if run for longer time periods.

### Example 3: HCl Leaching of Catalyst Material Using Sodium Chlorate as an Oxidiser

Leaching of Pd/Mo/Sn/zirconia material with hydrochloric acid and sodium chlorate as an oxidiser is described in this example.

7 mol/L hydrochloric acid was prepared by dilution of 585 mL (7 moles) 37% w/w concentrated analytical reagent grade hydrochloric acid into a 1 litre volumetric flask. The solution was made to volume using demineralised water and shaken to ensure homogeneity. The density of the prepared acid was 1.11 g/cm³.

400 mL of 7 mol/L hydrochloric acid was measured into a 500 mL flat bottomed baffled (x3) borosilicate glass reactor. A 5-port borosilicate glass lid was clamped in place and the reactor positioned on top of a hotplate. A stirrer guide was connected to the middle port, and through this a 5 cm diameter, Teflon™ coated, pitched blade (downflow) impeller was submerged in the acid approximately 1 cm from the base of the vessel. The impeller shaft was connected to an overhead stirrer motor.

Temperature was controlled using a thermostat connected to the hotplate and by a Teflon™ probe within the solution. The volume was kept constant by using a spiral-type reflux condenser connected to a port of the reactor lid. Stoppers were used in the free ports. Teflon™ joint clips were used to prevent the ground glass adapters becoming loose.

The catalyst sample (40.12 g) was slowly charged through a glass funnel into the stirred acid at 300 rpm and 19 °C. On completion of the addition the funnel was removed and replaced with a stopper. A few bubbles of gas were seen during the addition, and some immediate dissolution occurred with the solution turning a pale orange colour. The temperature remained constant during the solid addition which was completed in less than five minutes.

The equipment was thus setup for leaching of metal from the supported catalyst using HCl. Upon heating to 95 °C (which took 45 minutes) it was apparent further dissolution had occurred since the solution had darkened in colour to a deep orange colour. A sample was taken (5 mL) using a 0.45 μm syringe filter disc to remove any solids. The reaction was then allowed to continue for a further 90 minutes with samples taken after 45 minutes and after 90 minutes. There was no visible colour difference between these samples.

Since there was no visible colour difference in the samples taken between 45 and 90 minutes, sodium chlorate was added to ensure leaching of remaining palladium. Narrow bore (0.8 mm) tubing was connected to a peristaltic pump to deliver 450 g/L sodium chlorate solution from a measuring cylinder. The sodium chlorate line was primed to remove air and the tubing fitted into a connector and placed into a port on the vessel lid. A nitrogen line was added with a flow rate set to 1.0 L/min. This modified equipment setup was used for leaching of metal from the supporter catalyst using HCl with the addition of sodium chlorate.

Sodium chlorate addition was initially started at 0.5 mL/min, but this was too fast, evidenced by a large amount of chlorine generated. After the first 5 minutes, a sample was taken, and the chlorate addition was lowered to 0.25 mL/min. Further samples were taken 55 minutes after chlorate addition and after 175 minutes. The mixture was then left stirring whilst cooling under a nitrogen flow for approximately an hour until the temperature of the leachate reached 40 °C.

The leach liquor was filtered by vacuum through a 7 cm diameter GF/F (0.7 μm porosity) filter into a 1 L Buchner flask. The leach liquor was then transferred to a 500 ml bottle, shaken and sampled.

A second 1 L flask was used to collect demineralised water washings from the reactor, to aid the transfer and also to wash the solid. Total washing volume was 183 mL. The washings were slightly cloudy in appearance. The leached catalyst was then allowed to dry and was weighed (41.11 g).

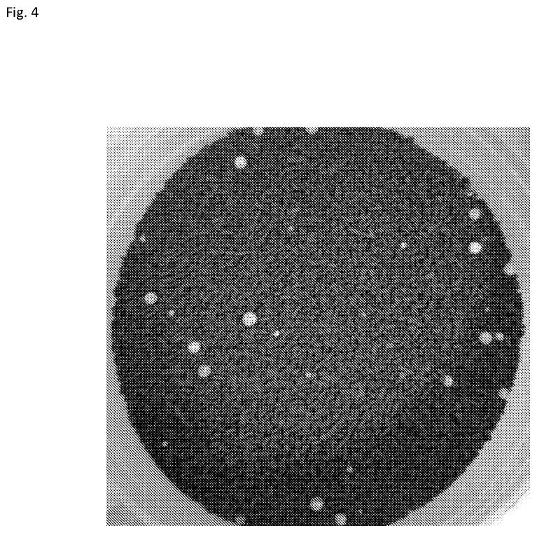

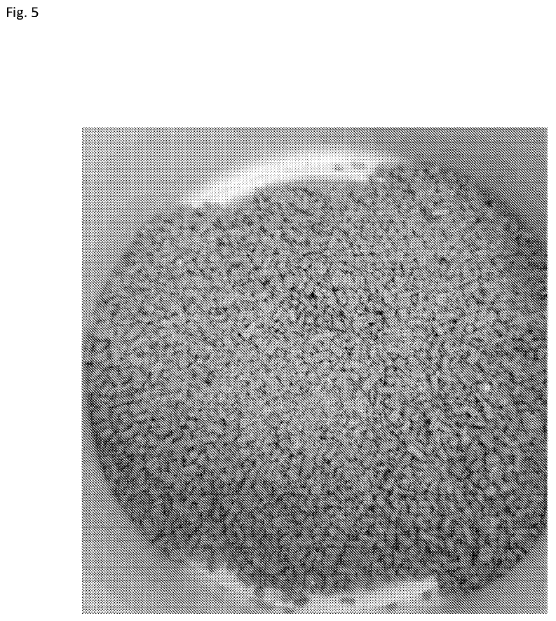

FIG. 4 shows the supported catalyst before leaching while FIG. 5 shows the catalyst after leaching.

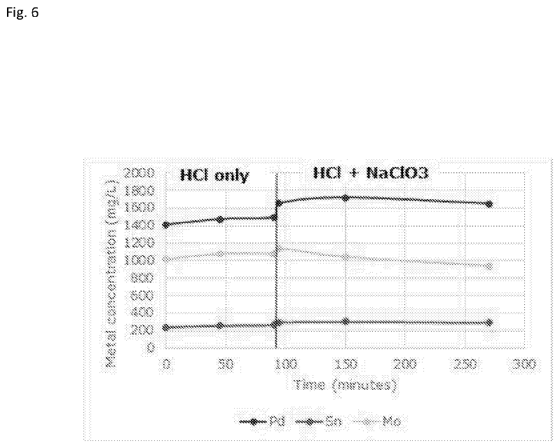

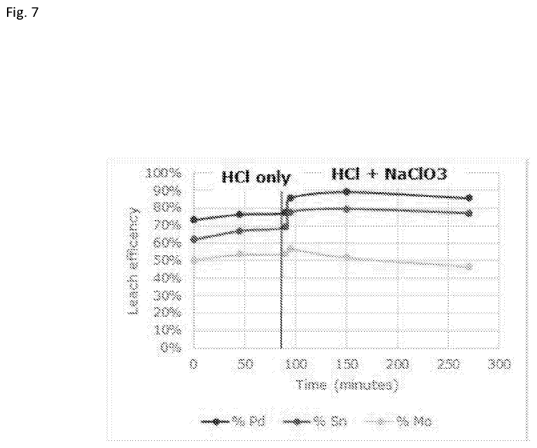

Samples of the leachate were analysed using ICP spectroscopy. FIG. 6 shows a graph of leached metal concentration vs time during initial leaching using HCl only followed by leaching using HCl and sodium chlorate. FIG. 7 shows a graph of % leached metal vs time during initial leaching using HCl only followed by leaching using HCl and sodium chlorate.

Results indicate that hydrochloric acid (7 M) is a suitable lixiviant for the dissolution of Pd from the support at 95 °C under reflux conditions. Leach efficiencies for Pd(78%), Sn (69%) and Mo (54%) were all high and all showed fast kinetics. The ZrO₂ support remains substantially insoluble throughout. Addition of sodium chlorate showed improvement in the leachability of Pd(86%) and Sn (77%).

### Example 4: HCl/H₂O₂ Leach of Crushed Catalyst Material

The aim of this example is to leach all, or substantially all, of the Pd, Mo and Sn from the zirconia base of the catalyst using 7 M HCl and H₂O₂ at a max flow rate of 0.17 ml/min. The catalyst material is crushed prior to leaching.

34 g of spent catalyst was weighed, transferred to a clean pestle and mortar, and crushed. Once crushed, the material was transferred to a 500 mL flange vessel and weighed by difference. 33.21 g was used in the leach. 330 ml of 7M HCl was added to the flange vessel via one of the open ports and the temperature was set to 70 °C. The other ports contained a condenser, an overhead stirrer, tubing for the hydrogen peroxide addition, and two stoppered ports.

A Gilson pump was set up with a pump rate set to 1.25 speed (0.14 mL/min). The tube was primed and inserted into an available port through a connector and sealed off with parafilm. The overhead stirrer was set to 150 rpm. Once the temperature of 70 °C was reached, addition of peroxide was started and observed to ensure the reaction wasn't too effervescent.

After 3 minutes the rate of peroxide addition was increased to 1.5 (0.17 mL/min) as there was no excessive reaction. The reaction continued at the rate of 0.17 mL/min for 2 hours before increasing to 1.75 (0.2 mL/min). Peroxide addition continued at 0.2 mL/min for another hour before increasing to 2 (0.23 mL/min) for the final hour. Samples were taken prior to H₂O₂ addition and then every hour. A further sample was taken after cooling and a final sample taken after filtration. All samples for analytical analysis were filtered through a 0.45 μm SFCA filter. The resultant liquor was filtered via vacuum filtration, through a GF/F filter paper into a Buchner funnel. Residue was dried under vacuum for 10 minutes before being left to air dry.

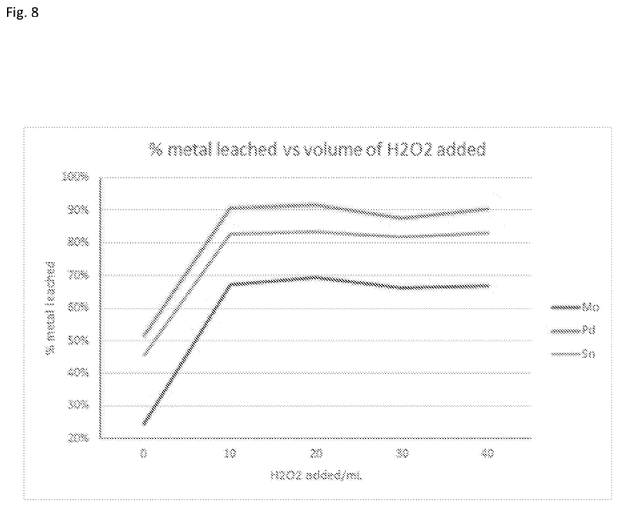

Samples were analysed using ICP spectroscopy. FIG. 8 shows a graph of % leached metal vs volume of H₂O₂ added.

Crushing the spent catalyst increased the available surface area, which allowed for more metal to leach in the acid prior to peroxide addition, as demonstrated in FIG. 8. Additionally, crushing allowed for the peak of metal leaching to be met earlier and with less peroxide.

### Example 5: Parameter Variations for Leaching

Samples of supported catalyst material have been subjected to leaching at a number of different temperatures (20 °C, 70 °C, 95 °C) and in both crushed and uncrushed form. The method involved weighing 30 g of spent catalyst into a 500 mL baffled flange top vessel set up with an overhead stirrer, a port to allow for H₂O₂ addition, a PTFE temperature probe, and two stoppered ports. A sample was taken after 1 hour of leaching with no oxidant, and after a further hour of leaching with hydrogen peroxide as the oxidant. Samples of both acid and water washes were also obtained. All samples have been analysed by ICP spectroscopy. Results are summarized in the tables below.

| | Pd | Sn | Pd | Sn | sum Pd | sum Sn | % leach | % leach Pd | % leach Sn | % leach Sn |
|---|---|---|---|---|---|---|---|---|---|---|
| Sample | mg/L | mg/L | mg | mg | mg | mg | Pd (=1%) | (= 1.18%) | (= 0.4%) | (= 0.32%) |
| 20° C. non crushed with oxidant | 990.75 | 269.10 | 302.18 | 82.07 | | | | | | |
| 20° C. non crushed acid wash | 190.82 | 56.23 | 19.08 | 5.62 | | | | | | |
| 20° C. non crushed water wash | 32.00 | 5.13 | 2.94 | 0.47 | 324.20 | 88.17 | 99.08% | 83.97% | 67.37% | 84.21% |
| 20° C. crushed with oxidant | 935.68 | 255.41 | 299.42 | 81.73 | | | | | | |
| 20° C. crushed acid wash | 348.60 | 102.57 | 13.94 | 4.10 | | | | | | |
| 20° C. crushed water wash | 46.79 | 7.96 | 7.81 | 1.33 | 321.18 | 87.16 | 100.59% | 85.24% | 68.24% | 85.31% |
| 70° C. non crushed with oxidant | 986.59 | 275.34 | 300.91 | 83.98 | | | | | | |
| 70° C. non crushed acid wash | 300.81 | 90.45 | 22.26 | 6.69 | | | | | | |
| 70° C. non crushed water wash | 46.97 | 12.19 | 6.86 | 1.78 | 330.03 | 92.45 | 104.67% | 88.70% | 73.31% | 91.63% |
| 70° C. crushed with oxidant | 919.64 | 260.42 | 312.68 | 88.54 | | | | | | |
| 70° C. crushed acid wash | 192.75 | 59.24 | 18.12 | 5.57 | | | | | | |
| 70° C. crushed water wash | 7.37 | 4.83 | 0.70 | 0.46 | 331.49 | 94.57 | 103.69% | 87.87% | 73.95% | 92.44% |
| 95° C. non crushed with oxidant | 963.50 | 278.19 | 317.95 | 91.80 | | | | | | |
| 95° C. non crushed acid wash | 223.94 | 65.08 | 19.03 | 5.53 | | | | | | |
| 95° C. non crushed water wash | 22.32 | 6.30 | 1.25 | 0.35 | 338.24 | 97.69 | 97.90% | 82.96% | 70.69% | 88.36% |
| 95° C. crushed with oxidant | 992.48 | 294.35 | 322.56 | 95.66 | | | | | | |
| 95° C. crushed acid wash | 205.60 | 64.18 | 9.05 | 2.82 | | | | | | |
| 95° C. crushed water wash | 19.61 | 7.61 | 2.41 | 0.94 | 334.01 | 99.42 | 105.43% | 89.35% | 78.46% | 98.07% |

| | | 20 °C | | | |
|---|---|---|---|---|---|
| | 20 °C | non crushed | | 95 °C | |
| | non | with 10 | 20 °C | non | 95 °C |
| mg/L | crushed | ml oxidant | crushed | crushed | crushed |
| mg/L Pd no oxidant | 998.12 | 1005.78 | 955.63 | 1071.54 | 1077.66 |
| mg/L Pd + oxidant | 990.75 | 990.75 | 935.68 | 963.50 | 992.48 |
| mg/L Sn no oxidant | 279.08 | 269.90 | 260.83 | 307.58 | 313.14 |
| mg/L Sn + oxidant | 269.10 | 269.10 | 255.41 | 278.19 | 294.35 |

Results indicate that it is possible to leach palladium using HCl at a range of temperatures and that it is not essential to crush the catalyst material or use an oxidant, although there are some advantages to using crushing and an oxidant as previously discussed. It is envisaged that solid loadings will be increased (e.g., to 20%, or 30%) and that leach liquor will be reused with unleached spent catalyst to concentrate the leach liquor.

### Example 6: Processing of Leach Liquor to Recover Palladium

Leach liquors and washings produced from previous examples were combined and boiled down to concentrate the liquor before passing through a column packed with ion exchange/molecular recognition media to separate the Pd from the base metals, especially Sn.

Leach liquors and washings were combined into a 2 L beaker and stirred for 30 minutes. A sample was taken and submitted to analytical. Approximately half of the liquor was transferred to a 2 L round bottom flask and set up in a distillation apparatus set to 180 °C mantle temperature (105-110 °C vapour temperature) and topped up until all liquor was added. The liquor was boiled down until approximately 100 mL remained, and then further diluted to 160 mL using 6 M HCl.

16.05 g of SuperLig™ 2 resin was weighed into a beaker and combined with ~10 mL 6 M HCl. The resin was allowed to soak briefly before transferring to the column (35 mm diameter fitted with 2 adjustable end pieces) and excess acid was drained leaving a bed height of 2.7 cm and a bed volume of 25.96 cm³. The feed (Pd 5.5 g/L) was filtered under vacuum through a 0.45 μm PVDF membrane prior to passing through the column. Feed was introduced to the column at 1.5 mL/min (Gilson minipump 3 set at 25.5) with the intention to overload at 110%, 160 ml of feed was passed through the column and the raffinate was collected, and a sample taken. 6 M HCl wash was passed through the column at 1.5 mL a minute, followed by a water wash at the same rate. These portions were collected together, and a sample was taken.

1 M ammonium sulphite was passed through to elute the Pd on the column at a rate of 0.75 mL/min and the strip was collected as a Pd(NH₃)(SO₄) solution. The column was again washed with water and 6 M HCl, at a rate of 0.75 ml/min and these portions were collected together and sampled. The Pd(NH₃)(SO₄) solution was then treated with HCl and H₂O₂ to precipitate the palladium as a Pd(NH₃)₂Cl₂ salt. Recovery of palladium as a precipitated Pd(NH₃)₂Cl₂ salt was thus achieved. Examples of how to use Superlig™ 2 have been published by IBC Advanced Technologies, Inc., (see, for example, Izatt, S. R.; Bruening, R. L.; Izatt, N. E. Green Chemistry Approach to Platinum Group Metals Refining, International Precious Metals Institute, 38th Annual Conference, Orlando, FL Jun. 7-10, 2014; Selective Recovery of Platinum Group Metals and Rare Earth Metals from Complex Matrices Using a Green Chemistry/Molecular Recognition Technology Approach, Metal Sustainability: Global challenges, Consequences, and Prospects, First Edition. Edited by Reed M. Izatt, @ 2016 John Wiley & Sons, Ltd. Published 2016 by John Wiley & Sons, Ltd.; and other publications from IBC Advanced Technologies, Inc.). Mass balance on the output found that Pd recovery was 99.2%. Additionally, the precipitated Pd(NH₃)₂Cl₂ salt met market grade specifications.

While the process of this specification has been exemplified for a supported palladium catalyst, it should also be noted that the techniques as described here can also be used for recycling a supported platinum catalysts using the acid leaching process followed by recovery of platinum using a different ion exchange/molecular recognition resin which is selective for platinum. For example, publications by IBC Advanced Technologies, Inc. also disclose Superlig™ resins which are selective for platinum rather than palladium, and these can be used in combination with the acid leaching process as described herein to recover platinum from ceramic supported platinum catalysts without the requirement for smelting. As such, this specification also enables the recovery of platinum by a hydrometallurgy route with the potential for the ceramic support to be reused enabling a more sustainable recycling route for both ceramic supported platinum catalysts as well as ceramic supported palladium catalysts.

While this invention has been particularly shown and described with reference to certain examples, it will be understood to those skilled in the art that various changes in form and detail may be made without departing from the scope of the invention as defined by the appended claims.

1. A method of recycling a supported palladium or platinum catalyst comprising palladium or platinum and base metal disposed on a ceramic support, the method comprising:
leaching the palladium or platinum and the base metal from the ceramic support using a hydrochloric acid leachate to produce a hydrochloric acid leach liquor comprising the palladium or platinum and the base metal;
passing the leach liquor through a column comprising material which selectively adsorbs the palladium or platinum;
eluting the palladium or platinum from the column using an eluent to produce a solution comprising the palladium or platinum; and
treating the solution comprising the palladium or platinum to recover the palladium or platinum.

2. The method according to claim 1, wherein the base metal comprises one or more transition metals and/or one or more post-transition metals, optionally one or both of tin and molybdenum.

3. The method according to claim 1, wherein the ceramic support is a metal oxide, a metal nitride, or a metal carbide material.

4. The method according to claim 1, wherein the ceramic support comprises zirconia.

5. The method according to claim 1, wherein the ceramic support is not subjected to a thermal or chemical decomposition treatment.

6. The method according to claim 1, wherein after leaching the palladium or platinum and the base metal from the ceramic support, the ceramic support is recovered and re-used.

7. The method according to claim 1, wherein the hydrochloric acid leachate has a hydrochloric acid concentration of: at least 1 M, 2 M, or 3 M; no more than 8 M, 7.5 M, or 7 M; or within a range defined by any combination of the aforementioned lower and upper limits.

8. The method according to claim 1, wherein the hydrochloric acid leachate further comprises an oxidant.

9. The method according to claim 8, wherein the oxidant is hydrogen peroxide or chlorate.

10. The method according to claim 1, wherein the leaching step is carried out at a temperature of: at least 20, 30, or 40 °C; no more than 95, 80, or 70 °C; or within a range defined by any combination of the aforementioned lower and upper limits.

11. The method according to claim 1, wherein the supported palladium or platinum catalyst is ground or milled prior to leaching.

12. The method according to claim 1, wherein the material in the column comprises a polymer resin.

13. The method according to claim 12, wherein the polymer resin comprises an ion exchange or molecular recognition resin.

14. The method according to claim 1, wherein the supported catalyst is a supported palladium catalyst and the eluent comprises (NH₄)₂SO₃ or NH₄HSO₃.

15. The method according to claim 14, wherein, after eluting the palladium, the solution comprising the palladium is treated with HCl and H₂O₂ to recover the palladium which is precipitated as a Pd(NH₃)₂Cl₂ salt.
